(19) United States
(12) Patent Application Publication
(10) Pub. No.: US 2007/0124972 A1
(43) Pub. Date: Jun. 7, 2007

(54) Method and apparatus for advertising on a vehicle

(76) Inventor: Peter W. Ratcliffe, Stevenson, MD (US)

Correspondence Address: NATH & ASSOCIATES, 112 South West Street, Alexandria, VA, 22314, US

(21) Appl. No.: 11/392,559

(22) Filed: Mar. 30, 2006

Related U.S. Application Data
(60) Provisional application No. 60/783,439, filed on Mar. 20, 2006.

(51) Int. Cl. G09F 21/04

(52) U.S. Cl. 40/591

(57) ABSTRACT

A method of advertising involves providing one or more advertisements that attach to a vehicle with an attachment mechanism, by way of a base. Each advertisement can be easily detached from the base for the purposes of attaching another advertisement without removing the base from the vehicle. An attractive cap using an identical attachment mechanism can be provided to cover the base. The base, the advertisement, and the cap can be provided as a set. Advertisement designs can be quickly and conveniently swapped at the vehicle user's discretion because they all utilize a common base design. Advertisers may provide the user with an advertisement for the advertiser's product, and with a plate compatible with the base already on the user's vehicle. The present invention provides a novel way for individuals to advertise their likings and a novel way for organizations to reach consumer attention by creating roaming advertisements for new and established brands and markets.

This application claims the benefit of U.S. Provisional Application No. 60/783,439 filed Mar. 20, 2006. The aforementioned provisional application's disclosure is incorporated herein by reference in its entirety.

### FIELD OF THE INVENTION

The present invention relates to methods of advertising, and more specifically, to a method and apparatus for displaying an advertisement attachable to a vehicle by way of a base.

### BACKGROUND OF THE INVENTION

Advertisers are constantly seeking new ways to reach consumer attention and create advertisements for both new and established brands and markets. Methods for advertising on a vehicle are known, but these are replete with problems and inconveniences such as the need for permanent modification of the vehicle, the risk of vehicle damage, the need for cumbersome equipment to secure a display to a vehicle, and generally unattractive ornamentation. The existing semi-permanent methods for attaching vehicle advertisements such as bumper stickers or roof placards make vehicle owners reluctant to advertise on their vehicles.

Consumers are constantly seeking new ways to show that they like, follow, or are affiliated with an entity such as a sports team, a school, a television series, a celebrity, or even a popular brand or mark. When a consumer shows such a following for an entity, they become a walking advertisement for that entity. Methods for advertising a liking or affiliation on a vehicle can involve signs or placards, but rarely involve vehicular ornamentation, for the reasons given above. Hood ornamentation is particularly rare, because pre-existing hood ornaments are often inconvenient to remove, replace or modify. Moreover, vehicle owners whose vehicles lack hood ornaments are reluctant to permanently modify their vehicles with a conspicuous ornament which may not be suited for all occasions.

The traditional hood ornament is provided by the manufacturer of the vehicle at the time of manufacture, and represents the make of the vehicle to which it is attached. Typically, the traditional hood ornament is attached to the vehicle in a semi-permanent manner (such as a hook and spring mechanism) which is not detachable without special tools and professional expertise. Even when the traditional hood ornament can be removed from its attachment mechanism, there is no guarantee that any replacement ornament other than one made by the vehicle manufacturer will be capable of attachment using the original attachment mechanism. Further, removal of the manufacturer-supplied ornament typically leaves on the hood an unattractive hole or an unornamented mount; neither is attractive, and both can quickly become clogged with dirt and debris under normal road conditions.

In this way, one can think of the vehicle hood as an advertising space that, until this invention, has been almost exclusively reserved for the use of the manufacturer of the vehicle. One can also think of hood ornamentation as a way for an individual to advertise which has heretofore been too mechanically complex and too permanent in its affixation to allow for easy, repeatable advertisement, and which has required a permanent modification affecting the original condition of the vehicle.

### SUMMARY OF THE INVENTION

The present invention is directed to a novel method of advertising, and more specifically to a method and apparatus for displaying an advertisement attachable to a vehicle by way of a base. An advertisement and an attachment mechanism are provided to a vehicle user who has a base attached to his vehicle. The advertisement includes no indicia associated with the vehicle make. The advertisement uses the attachment mechanism to attach to the vehicle by way of the base, and can be easily detached from the base for the purposes of attaching another advertisement without removing the base from the vehicle. An attractive cap using an identical attachment mechanism can be provided to cover the base. The base, the advertisement, and the cap can be provided as a set, which allows the user to advertise a liking at some times, and to make the base less pronounced and conspicuous at other times.

Advertisement designs of different shapes and sizes, advertising likings for different entities, can be quickly and conveniently swapped at the vehicle user's discretion. Each advertisement may be conspicuous or inconspicuous. The advertisements can include low-profile medallions, advertisements of athletic franchises, and advertisements for products. All of the advertisements may be easily interchanged because they all utilize the base design presently on the user's vehicle. The base may be attached to the vehicle by a strong adhesive layer, and may provide a mechanically secure mechanism for holding the advertisement in place. The advertisement can attach to the base with a plate having one or more feet which clip into one or more recesses formed by extensions protruding from the base. If needed, the base may be removed with no damage to the vehicle surface.

Advertisers may provide the user with an advertisement which includes indicia related to the advertiser's product, and with a plate compatible with the base already on the user's vehicle. The user can place this advertisement on his vehicle for an indefinite period of time, and then return to any of his previous advertisements.

It should become clear from the descriptions below that the present invention provides not only a novel way for individuals to advertise their likings by purchasing or possessing multiple advertisements, but also a novel way for organizations to reach consumer attention by providing advertisements and creating roaming advertisements for new and established brands and markets.

These and other aspects, objects, features and advantages of the present invention will be more clearly understood and appreciated from a review of the following detailed description of the embodiments and appended claims, and by reference to the accompanying drawings.

### BRIEF DESCRIPTION OF THE FIGURES

In the detailed description of the invention presented below, reference is made to the accompanying drawings in which:

FIG. 1 shows an elevation view of an embodiment of an advertisement and attachment mechanism for advertising a liking according to the provided method.

FIG. 2 shows an elevation view of the advertisement and attachment mechanism of FIG. 1 attached to the hood of a vehicle.

FIG. 3 shows an exploded elevation view of the advertisement and attachment mechanism of FIG. 1 with the associated key.

FIG. 4 shows an elevation view of a cap and attachment mechanism for use according to the provided method.

FIG. 5 shows an elevation view of a set including a cap and attachment mechanism, an advertisement and attachment mechanism, a base, and an adhesive layer for use according to the provided method.

FIG. 6 shows an exploded side view of the advertisement and attachment mechanism of FIG. 1.

FIG. 7 shows the advertisement and attachment mechanism of FIG. 1 in a cutaway view from above, and includes markings showing the use of the key to unlock the attachment mechanism.

FIG. 8 shows an exploded view of a second embodiment of an advertisement and attachment mechanism for advertising a liking.

FIG. 9 shows an elevation view of an embodiment of a sport-affiliated advertisement and attachment mechanism for advertising a liking.

FIG. 10 shows a side view of an embodiment of a figurine-based advertisement and attachment mechanism, and includes an optional base extender for leveling the advertisement.

FIG. 11 shows an elevation view of a banner-type advertisement and attachment mechanism.

FIG. 12 shows a side view of an alternate embodiment of a base for an advertisement.

### DETAILED DESCRIPTION OF THE INVENTION

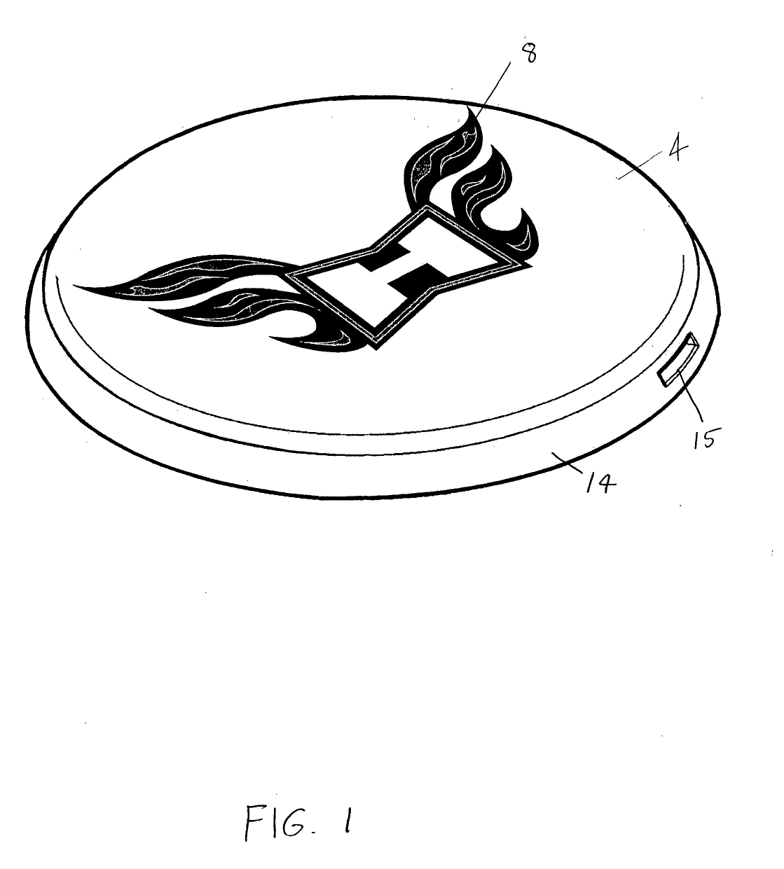

FIG. 1 shows an embodiment of an advertisement according to the provided method. The advertisement 4 is in the shape of a low-profile medallion, with a face for presenting indicia. It should be clear, however, that this is only one optional shape for an advertisement. Other shapes are shown and described in this application, including banners, mascots, helmets, vertical medallions, raised medallions, relief designs, domed medallions, and medallions specifically designed for sideways or upside-down placement. Those of ordinary skill in the art will appreciate that any shape capable of advertising without compromising the safety or view of a vehicle operator may be placed on a vehicle with this method.

On the face of the advertisement can be found indicia 8 of an entity which is to be advertised. The entity can be a corporation, a product, a product line, a corporate logo, a sports franchise, an athlete, a celebrity, a musician, a piece of sports equipment, a pet, a team number, a service, a trademark, a service mark, a novelty item, a game, or any other entity which one of ordinary skill in the art wishes to advertise. The indicia 8 can include words and images, but even the shape of the advertisement 4 itself may constitute the indicia, if this shape shows a liking for an entity. The indicia 8 can show a liking for more than one entity simultaneously. For example, an advertiser can provide an advertisement having his corporate logo displayed prominently near the image of a famous athlete, thereby demonstrating liking for the corporation and the athlete simultaneously.

The advertisement described herein serves a very different purpose than a traditional hood ornament described in the Background of the Invention. The traditional hood ornament almost exclusively demonstrates nothing more than the make of the vehicle to which it is attached. Accordingly, the indicia on the advertisement according to the present invention is unrelated to the make of the vehicle, and instead is related to one or more entities for which a user wishes to advertise.

In FIG. 1, the advertisement 4 is attached by way of its attachment mechanism (not visible) to a base 14. Base 14 contains an opening 15 into which a key may be inserted to unlock the attachment mechanism and release the advertisement from the base. A rectangular opening is shown, but any shape may be used for accessing a release mechanism with a key. The base can be made of any material suitable for the rigors of outdoor vehicular use, including steel, aluminum, brass, plastic, rubber, metal alloys, ceramic, fiberglass, or any solid construction material generally. Similarly, the advertisement 4 can be made of any material or composite of materials suitable for displaying indicia. This can include a single piece of plastic, metal, or glass, or a composite design such as a metal bottom and a clear plastic covering, or a clear plastic sleeve or container into which a cardboard or paper indicia-bearing sheet is placed. It should be noted that the advertisement can be made of a durable material if it is intended to last for a long time, or of a disposable material if it is intended to be thrown away soon after display (for example, to advertise an upcoming one-time event). The advertisement can optionally contain electronic elements which allow it to blink, shine, or move. The advertisement can contain in its body, in its base, or between the two, an electronic transmitter such as an RFID transmitter for use as a highway toll pass (like the EZPass system). The advertisement can contain an antenna for use with satellite radios, satellite and cellular telephones, standard radios, CB and HAM radios, or any other device requiring an inconspicuous antenna. The advertisement may have mechanical parts which allow it to change shape or form under certain conditions. The advertisement can be a collectors item of limited production, and can be a collectible souvenir. Those skilled in the art of outdoor advertising will doubtless know of many other materials or technologies which can be used to form an attractive advertisement.

Importantly, once the base is attached to a vehicle, it need not be removed to introduce different advertisements. Advertisement designs of different shapes and sizes, and advertising likings for different entities, can be quickly and conveniently swapped at the vehicle user's discretion. As an example, a vehicle user may purchase a base and advertisement to advertise his liking of a football team. When football season ends, the user may purchase a different advertisement advertising his liking of a basketball team. This user can replace the basketball advertisement with a football advertisement quickly and easily, using no professional tools or expertise, and retain the football advertisement for next season. When the user drives his vehicle for work, he can remove the sports advertisements altogether, and place an advertisement on his vehicle advertising a liking for his place of employment, or can place a low-profile decorative advertisement bearing unobtrusive indicia. All of the advertisements may be easily interchanged because they all have plates that utilize the base design presently on his vehicle. A vehicle driver may remove the advertisement at any time to prevent theft, and may replace it with another advertisement, or with a cap, which will be described in detail below.

Engaging in the provided method, advertisers may subsequently provide this user with a free attractive advertisement which includes indicia advertising a product, and with a plate compatible with the base on the user's vehicle. The user can place this advertisement on his vehicle for an indefinite period of time, and then return to the previous advertisement. In this design, the base provided to users would be as standardized as possible, so as to maximize the number of advertisements that can be provided to the same user under the provided method without requiring the replacement of the base.

The base can be given away or sold to vehicle owners. The more vehicles which are predisposed with the base, the more attractive this advertising method becomes. Once a base is disposed on a user's vehicle, that base can be used to display advertisements bearing product-advertising indicia, advertisements bearing indicia of organizations unrelated to a product, or both. In this way, the total advertising market is broadened, and the advertising power is strengthened. Since some advertisements will express an individualized liking, and others will bear an advertisement encouraged by a product provider, it is difficult for targeted audiences of the advertisements to grow bored with the medium and ignore all similarly placed advertisements as product related. Rather, consumer attention will remain drawn to the advertisements of this method because, before looking, a consumer cannot predict if the advertisement before him expresses its owner's personal taste or a product advertisement.

Vehicle-based advertisements can occupy multiple sales markets. Low-end markets can be reached with inexpensive, disposable advertisements, or advertisements which carry a message relevant for a limited time. High-end markets can also be reached, with advertisements made from expensive materials or to exacting standards, or which display a classy brand or logo in an elegant design. The advertisement, plate, and base can be made of plastic, or any combinations of plastic and metal, including die-cast designs. Due to the unique design disclosed herein, owners of even the most expensive vehicles will be willing to place an advertisement on their hood, because the advertisement can easily be removed and replaced with an inconspicuous cap, fit to the same base, which can resemble a traditional hood ornament, or which can conceal the base entirely.

The advertisements can come with a case for protection and storage, which allows the user to keep advertisements inside the vehicle but out of view when not in use, without being damaged. Alternately, an owner may already own a case for storing one or more advertisements when not in use, thereby carrying a collection wherever he goes. Further, a user may have an additional base attached to the inside of his vehicle, where he attached the advertisement when not in use.

While the base used in this method is described as attachable to a vehicle with an adhesive layer, future models of vehicles may come with this style of base built into the hood of the vehicle. A factory-installed base can be present on some or all cars manufactured by a given car maker, as soon as the cars come off of the line. The carmaker can make the base design weather tight, and place it so it fits the overall design of the car. The base can be built into the hood, the roof, the interior of the car, or (as mentioned previously) anywhere where a user might wish to decorate his vehicle. The base can be easily concealed, and may originally come with a traditional hood ornament attached, or with a concealing cap. The base can be easily utilized with the described method of advertising, as it encourages advertisers to produce advertisements with an attachment mechanism that fits a known base design. The base design has a known large market. A vehicle buyer can purchase his vehicle with an advertisement already disposed on the hood, or can purchase the vehicle and then begin building a collection of advertisements.

Although the same attachment mechanism will be used for the various advertisements offered in this advertising method, different sized advertisements may be used to draw more or less attention to an advertisement. The advertisements can range from large diameter medallions and large objects, to tiny medallions and charms. It should also be recognized that, although conventional vehicles are generally discussed herein, all types of vehicles can be used with this advertising method, including the following non-exhaustive list: bicycles (on the frame, on the wheel, or on a helmet), motorcycles, trucks, vans, tractor-trailers, tractors and farm vehicles, novelty vehicles, street-cleaning and other maintenance vehicles (e.g. Zambonis, mowers), golf carts, scooters, and kid vehicles (e.g. tricycles, big wheels).

Numerous affiliations and organizations can be advertised with the unique method disclosed herein. The following non-exhaustive lists include numerous entities which a vehicle user might like to advertise on his vehicle. As an advertising method, each of these suggested entities can be advertised alone, or can be combined with unique product placement. In this way, a vehicle owner can advertise an affiliation, or can advertise a product while displaying his affiliation.
Politics and Civics: political affiliations (such as the anarchy “A”, the republican elephant, or the democratic donkey); armed forces logos, medallions, and mascots; military citations (such as the purple heart); veteran, POW, and MIA flags; national, state, and city flags, logos, and mascots; war memorial designs; civic organization (like the NRA or N.O.W.); city skylines; grassroots and civic organizers' ads.
Sports and Recreations: Sports equipment with or without team logos (such as hockey sticks, hockey masks, shoulder pads, lacrosse sticks, soccer balls, soccer nets, baseball bats, football helmets, baseball helmets, baseball caps, basketball jerseys, baseballs, footballs, basketballs, tennis rackets, tennis balls, badminton rackets, badminton birdies, volleyballs, volleyball nets, golf clubs, golf bags, golf carts, skis, surfboards, ski masks, bicycles, bike helmets, bike gloves, motorcycles, fishing rods, fishing tackle, cowboy hats, rodeo logos, lassos, hunting rifles, hunting game, NASCAR vehicles, NASCAR numbers, Indy racing vehicles, Indy racing numbers, athletes' numbers generally, athletes' images generally, midget football teams and logos, cheerleading logos, cheerleading slogans, pom-poms, sports shoes, wrestlers); sport and team mascots (NCAA, NFL, MLB, NBA, MLS, WWE, NASCAR); sports-related messages; resort names and logos; Trout unlimited or Bass logos; boating association logos; motorcycle brand logos; musical instruments; band instruments; music staffs; music characters (like the grateful dead bears); windsurfing vehicles; flying vehicles; boats; rockets; spaceships.
Awards: Novelty awards for charity or intramural competitions, trophies, medals.
Education: Logos or names for local elementary schools, middle schools, high schools, colleges, or universities; alumni-targeted ads such a collegiate letters or logos; sorority and fraternity letters, logos, or slogans; college or high school sports teams.
Objects of Affection: Dogs, horses, cats, birds, ferrets, rodents, and other pets or even farm animals; wedding photos or wedding rings; personalized photos; digital photo displays; favorite food items.
Brand placement: favorite brands like coke or Pepsi; brands of beer, wine, or spirits; brands of shoes or jackets; brands of cigarettes or cigars; brands of cereal and their mascots; playboy bunnies.
Children's interest: Disney characters; cartoon characters generally; television show characters; movie characters; theme-park tie-ins; cereal characters; comic book characters (e.g. Marvel entertainment).
Movies and Media: Movie studios; movie characters; cartoon characters; television characters; movie tie-ins; plays, theater, opera, and concerts; children's television figures; actors and actresses;
Methods of vehicle identification: Funeral signs; motorcade signs; dignitary and diplomat signs; wedding signs; company fleet identifications.
Slogans: popular catch phrases; brand slogans; song lyrics.
Religions and seasons: Holiday themed signs and logos; Christmas trees; Santa Claus; menorahs; religious symbols.
Occupation identifiers: stethoscopes; gavels; dollar signs; currency signs; architects tools; builders tools; beakers; chefs hats; cooking tools.
Memorials: images of lost loved ones; birth and death dates; images of dead celebrities; images of dead musicians; images of dead athletes.
Miscellaneous: spaceships, planets, rockets, globes, wind-driven mechanical objects, tools, miniature automobiles, geometric shapes, smiley faces, mythological heroes, superheroes, comic characters, famous historical characters, playboy bunny; movie studios; television studios.

Vehicle-based advertisements can be provided through many distribution channels. An non-exhaustive list of some distributors who could stock and sell such advertisements, or who could themselves advertise with this method, includes: Wal-Mart, K-Mart, Target, Home Depot, Lowes, C-Stores (Royal Farms), QVC, the Home Shopping Network, Staples, various internet vendors, Office Max, Dicks, Modells, Foot Locket, Sam's Club, BJ's, Costco, Advance Auto Parts, Pep Boys, Barnes & Noble (including university bookstores), Follet bookstores, and Borders Books and Music, other auto parts stores, Universities, Gas Stations, eBay, Amazon.com. Catalogs are also a useful point of sale for these advertisements, including publications like Sky Mall.

In addition, every major retail product has a “special markets” division which could utilize this advertising method. Such product lines range from low-end to high-end; a non-exhaustive list includes: Black & Decker, Sony, Kitchenaid, Lennox, Gucci, Coach, Swiss Army, Mattel, Hasbro and more.

Many different franchises and products may wish to advertise using this method. A non-exhaustive list includes: the NFL, MLB, the NHL, NASCAR, WWE, the NCAA, Disney, Pixar, Marvel Entertainment, Harley Davidson, CAT, Universal Studios, Playboy, Warner Brothers, the Grateful Dead, FOX, NBC, ABC, CBS, HBO, Showtime, Time Warner, and IMG.

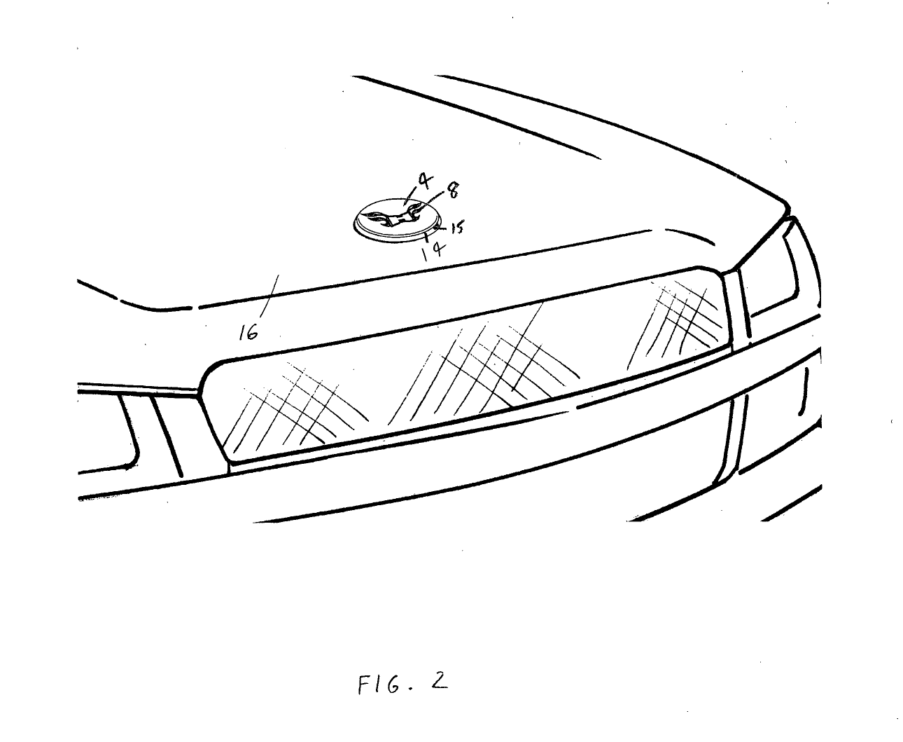

FIG. 2 shows an advertisement 4 attached to a base 14, which is itself attached to a vehicle 16. As discussed above, the advertisement 4 can be attached with an adhesive layer. The advertisement is shown in the standard location for a hood ornament, but can be placed elsewhere if desired. Key-insertion opening 15 should not be blocked by any element of the vehicle, so that a key can freely be inserted.

The base can be attached to the hood of a vehicle, but can be attached to other parts of the vehicle as well, including the roof, doors, dashboards, tailgates, bumpers, or any place where advertising can be done safely. While the base may be attached to the outside of the vehicle, it can just as easily be attached to the inside of the vehicle, when it can be placed on the dashboard, on the roof on, the side windows, on or in the glove box, on the seats, on the frame, or on the floor, to name only a few locations. Of course, the vehicle owner should consider any risk associated with the placement of an advertisement which might impair his ability to drive, and which might injure another passenger, driver, or an occupant of another vehicle.

When two or more bases are utilized, the vehicle owner need not remove an advertisement entirely when he wishes to replace it, but rather can swap advertisement locations. For example, an owner may keep a company logo affixed to the inside of his dashboard, and a football helmet to the hood of his car. On work days, he can swap advertisements between the two bases, such that his company logo is displayed on the outside of his vehicle, while the football helmet remains on display on his dashboard in anticipation of Sunday.

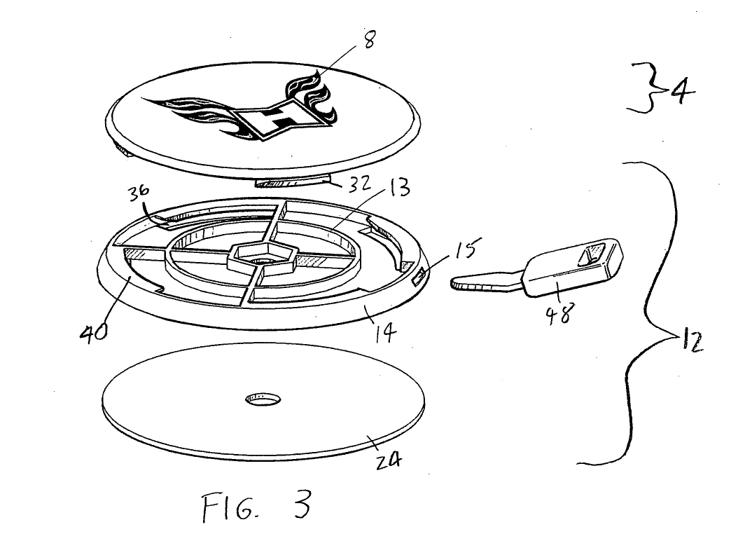

FIG. 3 shows an exploded view of the advertisement and attachment mechanism of FIG. 1 with the associated key. Here, the advertisement 4 and its attachment mechanism 12 can be seen, along with a key 48 for insertion into the previously-mentioned key-insertion opening 15 of the base for separating the parts of the attachment mechanism 12. The key is presented with an angled handle, making it well suited for insertion when there is little clearance near the base. However, the key can be of any shape, and can include any number of locking features, including indentations, notches, holes, circuits, or any other feature capable of allowing the proper key or device to release the advertisement. Of course, a low-security design might involve no key at all, and only a button or switch for separating the attachment mechanism in the manner described below.

The attachment mechanism 12 comprises a number of features visible in this figure, which will be addressed in turn. At the bottom of the figure can be seen an adhesive layer 24. This layer keeps base 14 attached to a vehicle (not shown). The layer is adhesive on both its top and bottom surfaces, and creates a firm attachment for the base 14 to the vehicle. It can be stamped to the exact diameter of base 14. Ideally, this layer should be strong enough to keep the advertisement attached to the vehicle under normal road conditions, such as winds caused by high speeds, and impact with dirt and gravel. However, the layer can be capable of being removed without damaging the paint or other surface features of the vehicle to which it is attached. For safety, the adhesive or object should break free or break apart if impacted in any way during a vehicle accident, so as not to cause injury. When attached by an adhesive mechanism, the base should ideally cause no permanent damage to the vehicle surface, such that once removed, all traces of the advertisement will be gone and the value of the vehicle will have been essentially unaffected. Many such adhesives are commercially available which can perform these functions well, including 3M PT1500 rubber based, double-sided stick tape. However, drivers should always consider safety when choosing where to adhere their advertisement.

Again referring to FIG. 3, one side of the adhesive layer is attached to a vehicle surface, and the other to the bottom of base 14. Base 14 as shown contains four extensions 40, or flanges, which extend inward from the rim at the top of the base 14. Each extension 40 also extends downward to the base at one end, defining an interior space 36 enclosed on four of six sides. The base can further include optional cutaway recess portions. Any debris that gets trapped in the base eventually finds its way to these recesses, where it is then held by the adhesive layer 24 and can be cleaned out at any time. The base can further include support ribbing 13 which can prevent the base from deforming during use.

While the base is shown with a flat bottom and flat adhesive disc, bases can also be made for hoods with compound shapes. Many techniques can be used to produce a base with a flat top surface (for attaching to the attachment mechanism) but a bottom surface of variable shape. Various flexible bases can be used: some have a bottom which remains flexible at all times, some have a bottom which deforms under pressure, and some have a bottom which deforms under known conditions like heat. As an example of the latter, one can provide a base which is rigid at normal operating temperatures, but which is flexible when hot. The base can be heated with a hair dryer, form fit to the vehicle hood, and then allowed to cool and harden, retaining a shape corresponding to the vehicle surface to which it will be applied. Alternatively, a disc-shaped base can used having a flexible “outer” ring for form-fitting to the vehicle, and a raised and rigid “inner” disc to which the advertisement attaches. In these cases and all those obvious to one skilled in the art, a base is provided which can attach to any hood shape, or to any curved or compound surface of a vehicle, including but not limited to edges, corners, dashboards, trunks, and roofs.

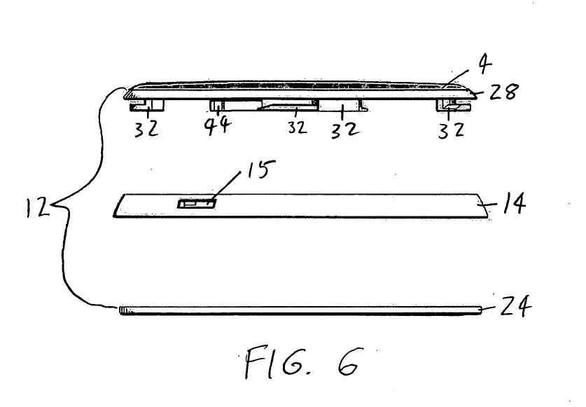

Still referring to FIG. 3, attached to the bottom of advertisement 4 is plate 28 (not visible), which is provided for connecting the advertisement to the base. Descending from plate 28 are four feet 32, of which only one is visible in this figure. Advertisement 4 with plate 28 are together inserted into the base by placing the foot or feet 32 into slots and then turning clockwise until the plate 28 is locked into place by a locking mechanism which is described in detail in the following description of FIG. 6. Together, the plate 28, base 14, adhesive layer 24 and components therein compose an attachment mechanism 12, although other combinations of other elements can compose an attachment mechanism for those skilled in the art. Plate 28 may be round, square, rectangular, trapezoidal, or may take on any shape which serves the appropriate role as part of the attachment mechanism 12. One skilled in the art can doubtless think of many ways to safely secure a removable advertisement to a vehicle, and the mechanism disclosed herein is merely an exemplary embodiment.

An example of dimensions appropriate for such an attachment mechanism include a plate 28 at least 3.3 inches in diameter at its bottom, with feet 32 connected to the plate 28 no more than 0.29 inches from the outside edge of the plate, where the feet extend no more than 0.12 inches from the bottom surface of the plate. A base less than 1 inch in height is typical and would be considered “low-profile”, although other sizes may be used. A medallion less than one inch in height is typical and would be considered “low-profile,” although other sizes may be used. Generally, other dimensions are possible for all components, and it can be seen that once a base 14 of known dimensions is disposed on a vehicle, advertisements with attachment mechanisms of corresponding dimensions will be attachable to the base.

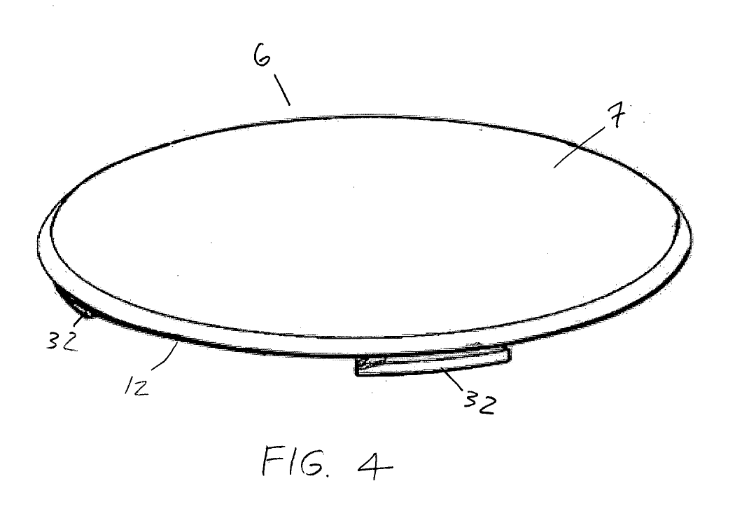

FIG. 4 shows a cap 6, and attachment mechanism 12 and feet 32, which can attach to and conceal the base (not shown). The cap is shown with a low-profile, sleek, disc-shaped design, with a glass-like surface. However, many other shapes and designs can be envisioned for the cap, and any shape is appropriate which could cover the base when no advertisement is being used. The cap 6 may be curved or flat, and may be wider or narrower than the base. The surface 7 of the cap can have images, words, indicia, colors, shapes, photographs, or patterns, or it may be given a single color which matches or compliments the vehicle. The cap 6 can attach to the base using the same type of attachment mechanism, or can cover the base in another manner, including extending past and over its edges.

The cap serves to make the base less conspicuous, and allows the user to discretely hide, or at least minimize, the presence of the advertisement system when not in use. The cap also serves to keep the base clean of debris when an advertisement is not in use. The cap enhances the advertising method disclosed herein, as it makes users more comfortable with displaying a liking in a playful, fun, or conspicuous way on their vehicle, as each user knows that he can remove the advertisement and replace it with an inconspicuous cap, using an attachment mechanism compatible with his base, at any time.

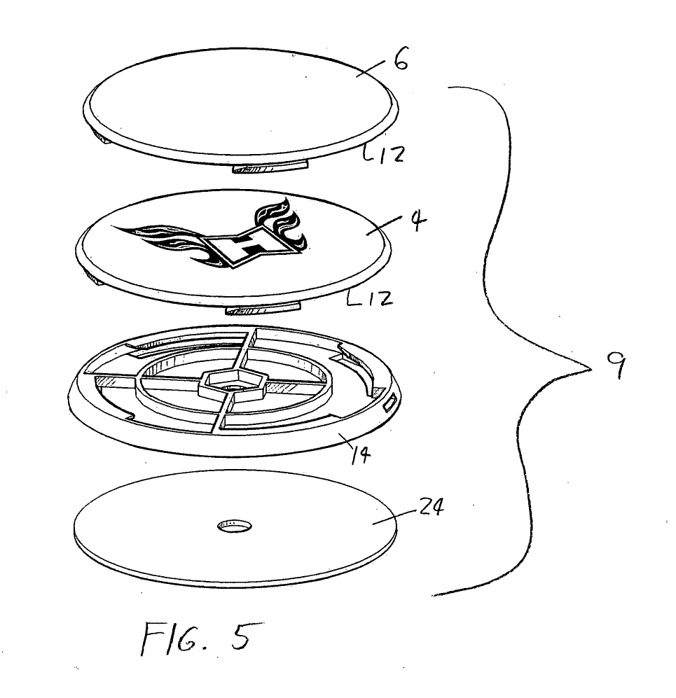

As shown in FIG. 5, the base 14 (optionally with adhesive layer 24), the advertisement 4 (with attachment mechanism 12), and the cap 6 (with matching attachment mechanism 12) can be provided as a set 9, which allows the user to advertise a liking at some times, and to conceal the base at other times. Advertisers can provide a user with a three-part system of a universal base, a cover, and one or more advertisements with attachment mechanisms. Alternately, an advertiser can provide a user with only an advertisement and attachment mechanism, for use with a base and cap already in the user's possession. Either scenario utilizes the method disclosed herein, wherein an advertiser provides an advertisement for advertising a liking, along with an attachment mechanism, to a user who decorates his vehicle. The user is comfortable decorating his vehicle, in part, because the base can be made inoffensive and inconspicuous by the use of this cap.

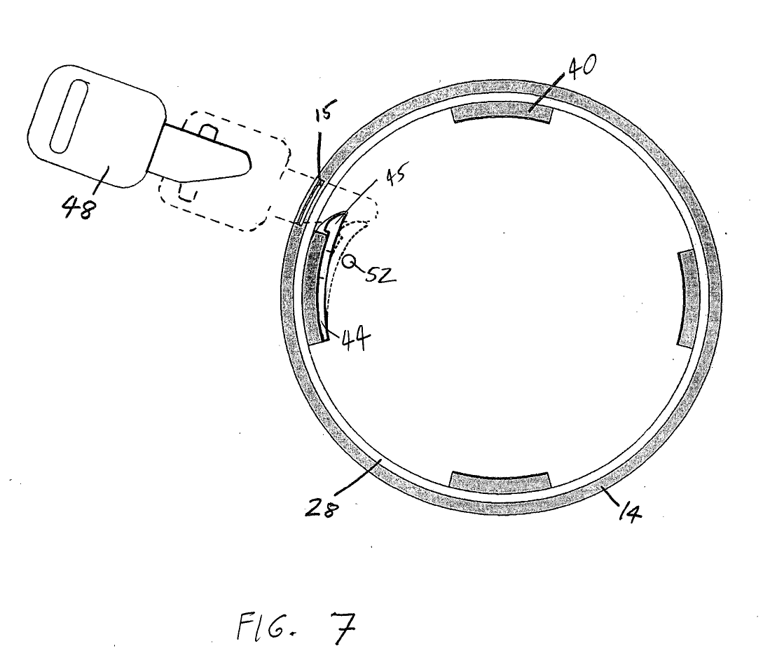

FIG. 6 shows an exploded side view of the advertisement and attachment mechanism of FIG. 1. The attachment mechanism 12 and advertisement 4 are again visible. As above, the adhesive layer 24 can be seen, along with the base 14 and key-insertion opening 15. Here, all four feet 32 can be seen descending from the plate 28—one on either side, and two in the center of the figure facing in opposite directions. It should be noted that the circular shape of the plate and base are an optional embodiment, and that other shapes for an attachment mechanism can be envisioned by those skilled in the art. In addition, to the left of the foot closest in view can be seen the locking clip 44 which secures one foot 32 of plate 28 in recesses 36 (not visible) and thus keeps plate 28 from rotating with respect to base 14. Clip 44 is disengaged by way of the key 48 (not visible); a description of the clip mechanism accompanies the following description of FIG. 7.

FIG. 7 shows the advertisement and attachment mechanism of FIG. 1 in cutaway from above, and includes markings showing the use of the key to unlock the attachment mechanism. Here, the cutaway view includes the circular base 14 and the extensions 40 which form the recesses 36 (not shown) into which the feet 32 (not shown) of plate 28 are turned. A clip 44 is provided on the underside of plate 28. The clip has a wide end 45 with an angled edge. When the plate 28 is first placed into the base 14, this wide end abuts the top edge of extension 40 nearest the open end. Consequently, when the plate is turned clockwise (to secure), the angled edge first glides along the corner of the extension 40, and then along the long side of the top of extension 40. Although not shown, when the feet are turned partially into the recesses 36, clip 44 is thus displaced from its normal location. In this intermediate state, the clip 44 is tensely pressed against the long side of extension 40, either by virtue of the elasticity of the material forming the clip (as in this figure), or by an additional tensioner such as a spring. Any material with a natural elasticity or spring force, or to which an artificial elasticity or spring force can be imparted, may be used for the clip.

When the feet are turned to the maximum allowed distance (that is, when they abut the interior rear walls of extensions 40), the above described tension causes the clip 44 to return to its natural state, as shown with the solid lines in this figure. In this state, the wide end 45 of clip 44 abuts the exterior rear wall of extension 40 and prevents the plate 28 from turning counterclockwise, while the end of the foot 32 (not shown) abuts the interior rear wall of extension 40 from within the recess 36 and prevents the plate from turning further clockwise.

The plate 28 can be removed from the base 14 by use of the key 48, which is inserted as shown with dashed lines. When inserted, the key 48 holds the clip 44 against stop 52 (as shown with dashed lines), such that the wide end no longer abuts the exterior rear wall of extension 40 and the plate may again be turned counterclockwise for removal. Once the key 48 has been removed and the wide end of the clip is completely free of extension 40, the clip 44 returns to its natural position.

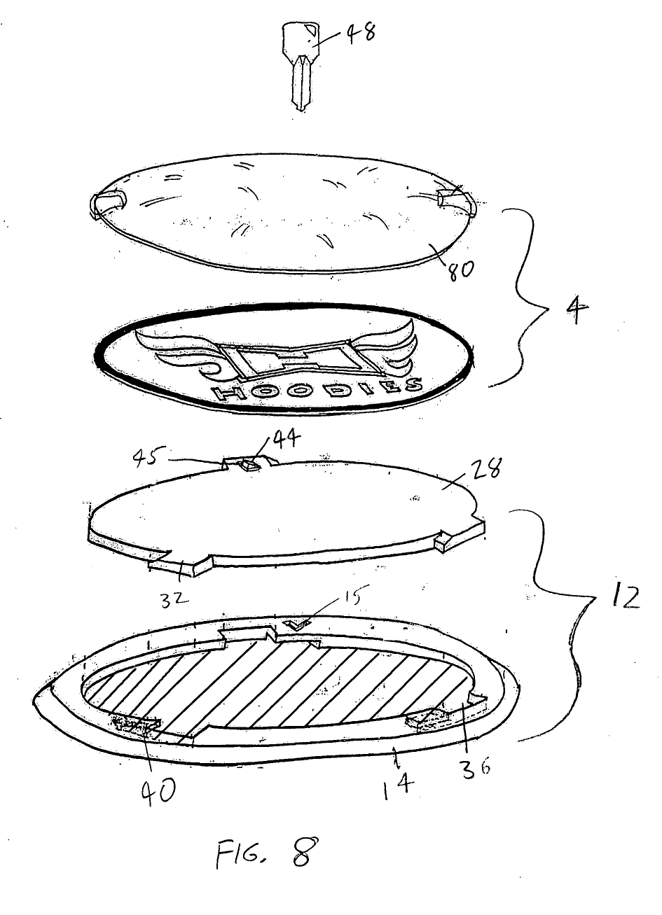

FIG. 8 shows an exploded view of a second embodiment of an advertisement and attachment mechanism for advertising a liking. In this embodiment, the advertisement 4 comprises a layer bearing indicia 8 and a clear protective layer 80, which can be formed of any transparent material. The indicia-bearing layer is attached to the plate 28, here shown with three feet 32, although other numbers of feet are possible. One foot bears a vertical clip 44 with an angled edge and a wide end 45. The base 14 includes recesses 36 formed by extensions 40. Like in the previous embodiment, the advertisement is rotated clockwise for insertion. When the feet 32 are fully turned into recesses 36, clip 44 springs up into the underside of the key-insertion opening 15, which is shaped specifically for the clip. Thus, the vertical spring tension of the clip 44 keeps the wide end 45 abutting the interior of the underside of the key-insertion opening 15 and prevents the plate from being rotated counterclockwise. As in the previous embodiment, the feet 32 abut the interior rear wall of each recess 36 and keep the plate from rotating further clockwise. When the key 48 is inserted into the key-insertion opening 15, the top of which being shaped to receive the key, the key engages the clip 44, opposing its tension and allowing the plate (and indicia-bearing layer as attached) to rotate counter-clockwise and again be removed.

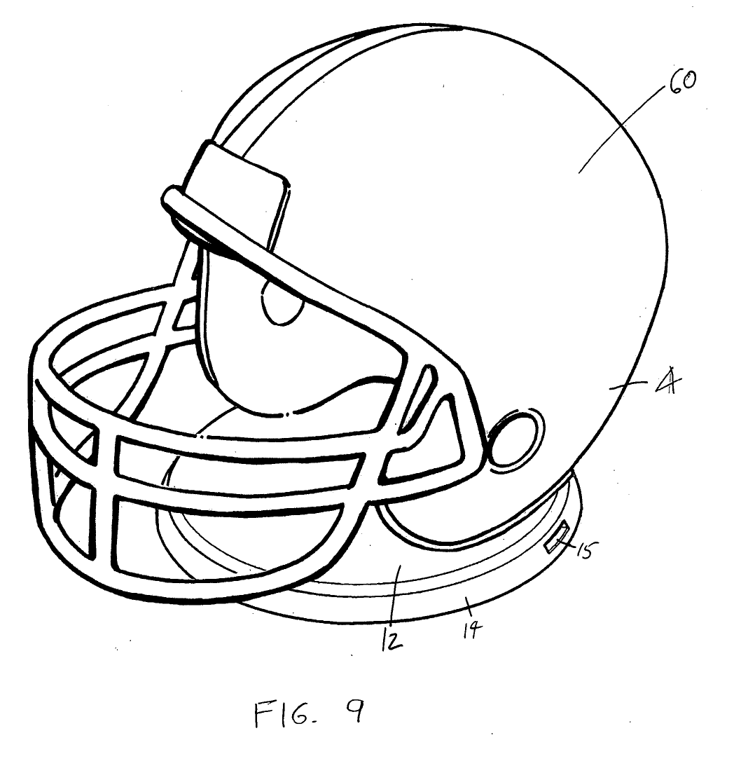

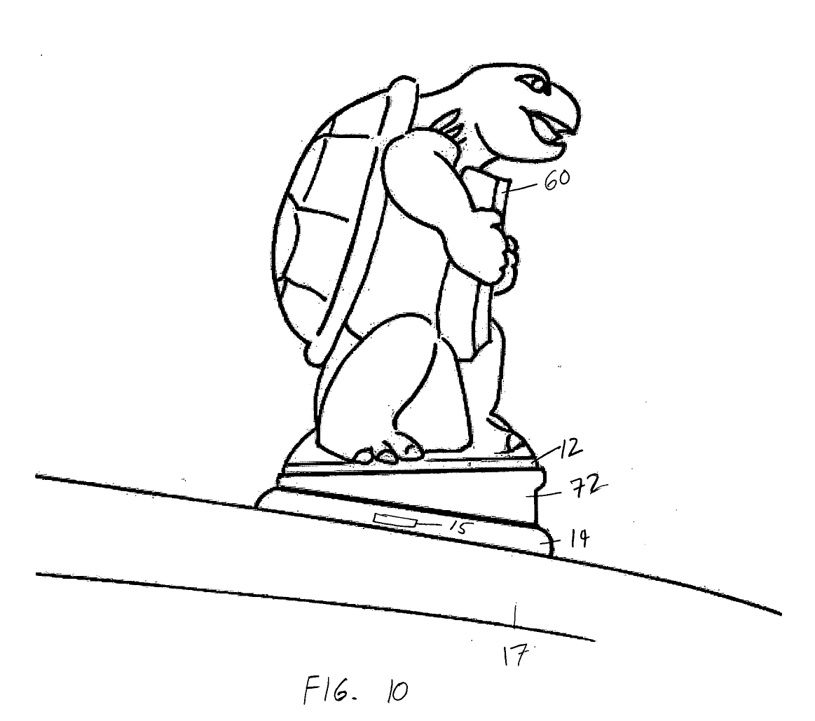

In FIG. 9, an advertisement 4 bearing indicia showing a liking for an athletic franchise 60 is shown. The athletic-franchise indicia 60 can include the shape of the advertisement, the colors of the advertisement, text appearing on or around the advertisement, graphics shown on the advertisement, or other features. The shape may involve a piece of athletic equipment (like the helmet shown), or the shape of a mascot, team logo, or other sports-related indicia as set forth above. In all cases, a base 14 (here shown with a key-insertion opening 15) is attached to a vehicle 16, and the advertisement possesses a plate 12 which is attachable to, and detachable from, the base. In FIG. 10, a figurine-based advertisement is shown. The figurine may be a sports mascot, a movie or television character, a cartoon character, a toy, an action figure, a doll, or any other figurine that can advertise. A base extender 72 is disposed between the base and the advertisement. The base extender increased the height of the advertisement by a fixed distance, and changes the angle of presentation of the advertisement. In this manner, a base 14 attached to a vehicle with a slanting hood 17 can still present a level advertisement. The base extender in its simplest form has a plate at its bottom and an additional base at its top, although more complex designs and shapes are possible. Such a base extender can be adjustable to fit different vehicles as well.

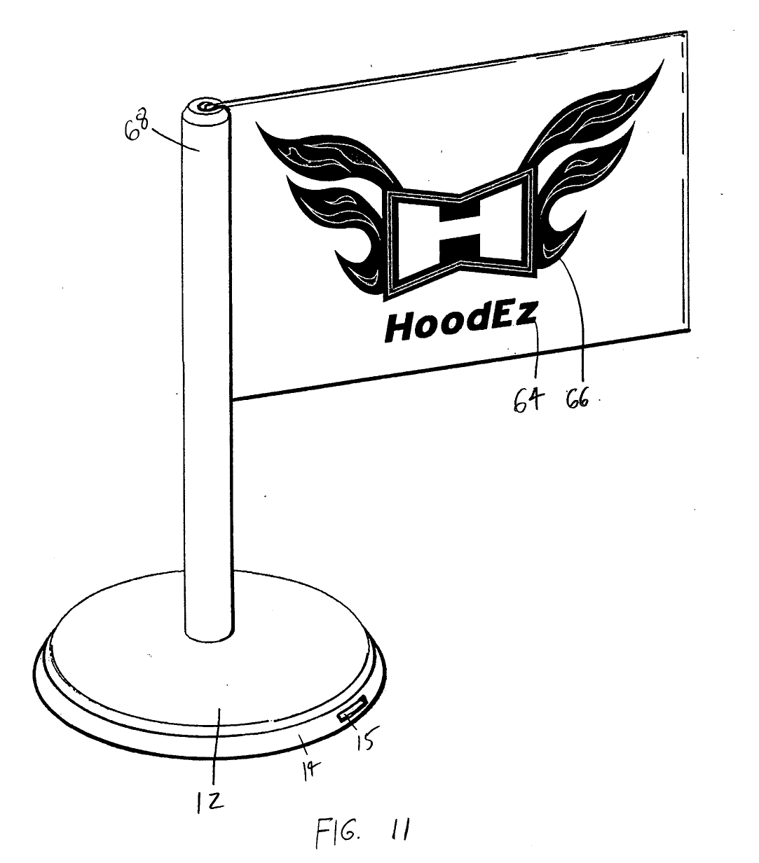

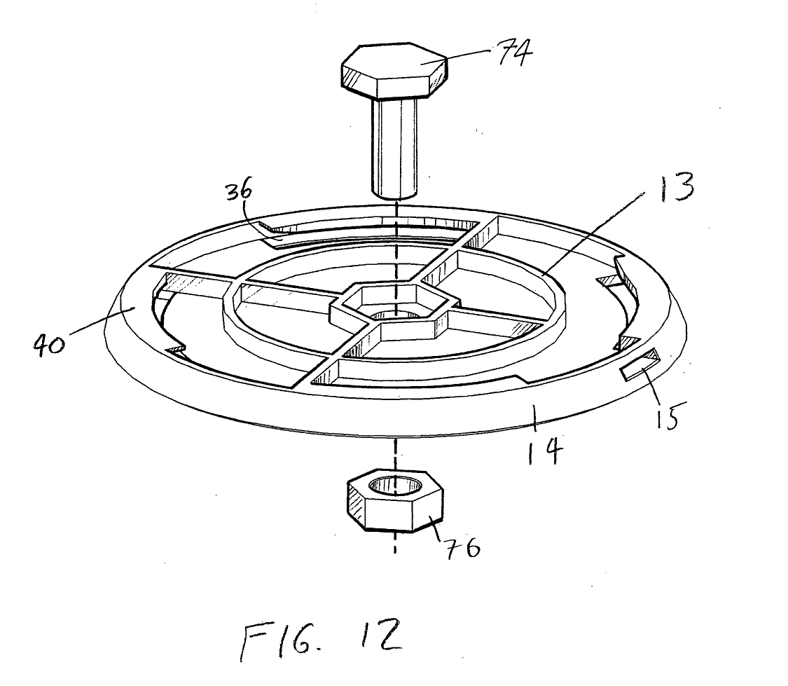

An additional example of an advertisement according to the present method is possible with the banner-type advertisement 68 of FIG. 11, which presents a large indicia-bearing banner. The banner can show graphical indicia 66 and textual indicia 64 relating to the same or different entities. As above, advertisers may place an image of an entity (like a celebrity) for which a liking is to be advertised, and include textual indicia of their corporate entity. Alternately, they can include images and words related to a product. The banner-type advertisement allows for even greater customization, as banners with different indicia can be replaced without replacing the pole which bears the banner.

Where allowed by law and safety regulations, semi-permanent means of attaching the base to a vehicle are possible, such as the attachment mechanism of FIG. 12. As above, a base 14 includes a key-insertion opening 15, extensions 40 forming recesses 36, and support ribbing 13. A hole can be drilled through the part of the vehicle where the advertisements are to be displayed, and bolt 74 and nut 76 can be placed through that hole to secure the base to the vehicle.

The advertisement, attachment mechanism, and base described herein can be constructed from any suitable material or materials, including but not limited to at least one wood, metal, alloy, polymer, glass, porcelain, elastomer, and combinations and derivatives thereof. Non-limiting examples of metals and alloys include iron, steel, aluminum, tin, copper, bronze, and combinations and derivatives thereof. Non-limiting examples of polymers and elastomers include thermoplastic polymers, thermoset polymers, an acrylate containing polymer, an acrylic containing polymer, an amide containing polymer, a carbonate containing polymer, a chlorinated polymer, a copolymer, an ester containing polymer, an ether containing polymer, a fluorinated polymer, a ketone containing polymer, a methacrylate containing polymer, an olefin containing polymer, a rubber, a styrenic containing polymer, a sulfur containing polymer, a vinyl containing polymer, a polyvinyl chloride containing polymer, elastomeric olefins, styrenic butadiene, acetate film, polystyrene, polyethylene, latex, polyvinyl chloride, silicone, polyvinyl alcohol, chlorinated polyethylene resins, ethylene vinyl alcohol, fluoroplastics, ionomers, polyacrylates, polybutadiene, polybutylene, polyethylene, thermal polyethylene, silicone, a silicone containing polymer, polyethylenechlorinates, polymethylpentene, polypropylene, thermal polypropylene, polystyrene, polyvinylchloride, polyvinylidene chloride, polyamide, polyamide-imide, polyaryletherketone, polycarbonate, polyketone, polyester, polyetheretherketone, polyetherimide, polyethersulfone, polyimide, polyphenylene oxide, polyphenylene sulfide, polyphthalamide, polysulfone, chlorinated polyethylene resin, allyl resin, melamine formaldehyde, phenol-formaldehyde plastic, silicone, polyurethane, epoxy, cellulosic, acrylonitrile-butadiene-styrene, liquid crystal polymer, polyacetal, polyacrylonitrile, thermoplastic elastomers, diisodecyl phthalate, and combinations and derivatives thereof. Non-limiting examples of wood include compositions with cellulosic fiber including particleboard, fiberboard, plywood, and combinations and derivatives thereof. Non-limiting examples of glass include fiberglass, porcelain, tempered glass, and combinations and derivatives thereof.

Having described the invention in detail and by reference to the embodiments thereof, it will be apparent that modifications and variations are possible, including the addition of elements or the rearrangement or combination or one or more elements, without departing from the scope of the invention which is defined in the appended claims.

What is claimed is:

1) A method of advertising, the method comprising:
providing an advertisement displaying indicia of one or more entities not associated with a vehicle make; and
providing an attachment mechanism that attaches said advertisement to a vehicle by way of a base, wherein said attachment mechanism is detachable from the base.

2) The method of claim 1, further comprising:
providing a cap which attaches to a vehicle by way of the base, wherein said cap is detachable from the base.

3) The method of claim 1, further comprising:
providing a second advertisement displaying indicia of one or more entities not associated with a vehicle make; and
providing a second attachment mechanism that attaches said second advertisement to a vehicle by way of the base, wherein said second attachment mechanism is detachable from the base.

4) The method of claim 1, wherein said step of providing an advertisement comprises:
providing a low-profile medallion having a face on which said indicia is shown.

5) The method of claim 1, wherein said step of providing an attachment mechanism comprises
providing an attachment mechanism that attaches said advertisement to a surface of a vehicle by way of a base.

6) The method of claim 1, wherein said step of providing an attachment mechanism comprises
providing an attachment mechanism that attaches said advertisement to a hood of a vehicle by way of a base.

7) The method of claim 1, wherein said step of providing an attachment mechanism comprises:
providing a plate,
providing at least one foot connected to the plate, each of said at least one foot being feedable into a recess formed by at least one extension protruding from the base, and
providing at least one clip clippable to said at least one extension and unclippable by way of a key.

8) The method of claim 1, wherein said step of providing an attachment mechanism comprises:
providing an attachment mechanism which attaches said advertisement to a vehicle by way of a base already disposed on the vehicle.

9) The method of claim 1, wherein said indicia advertises at least one athletic franchise.

10) The method of claim 1, wherein said indicia advertises at least one product.

11) A device for advertising, the device comprising:
an advertisement displaying indicia of one or more entities not associated with the vehicle make; and
an attachment mechanism that attaches said advertisement to a vehicle by way of a base, wherein said attachment mechanism is detachable from the base.

12) The device of claim 11, further comprising:
a cap which attaches to a vehicle by way of the base, wherein said cap is detachable from the base.

13) The device of claim 11, further comprising:
a second advertisement displaying indicia of one or more entities not associated with a vehicle make; and
a second attachment mechanism that attaches said second advertisement to a vehicle by way of the base, wherein said second attachment mechanism is detachable from the base.

14) The device of claim 11, wherein said advertisement is a low-profile medallion having a face on which said indicia is shown.

15) The device of claim 11, wherein said attachment mechanism attaches said advertisement to a surface of a vehicle by way of a base.

16) The device of claim 11, wherein said attachment mechanism attaches said advertisement to a hood of a vehicle by way of a base.

17) The device of claim 11, wherein said attachment mechanism comprises:
a plate,
at least one foot connected to the plate, each of said at least one foot being feedable into a recess formed by at least one extension protruding from the base, and
at least one clip clippable to said at least one extension and unclippable by way of a key.

18) The device of claim 17, wherein
said plate is at least 3.3 inches in diameter at its bottom;
said at least one foot is connected to said plate no more than 0.29 inches from the outside edge of said plate; and
said at least one foot extends no more than 0.12 inches from the bottom surface of said plate.

19) The device of claim 11, wherein said attachment mechanism attaches said advertisement to a vehicle by way of a base already disposed on the vehicle.

20) The device of claim 11, wherein said indicia advertises at least one athletic franchise.

21) The device of claim 11, wherein said indicia advertises at least one product.

22) A system for advertising, the system comprising:
means for advertising one or more entities not associated with the vehicle make,
means for attaching said means for advertising to the vehicle by way of a base, and
means for detaching said means for advertising from the vehicle.

23) The system of claim 22, further comprising:
means for covering the base when an advertisement is not in use.

24) The system of claim 22, further comprising:
a second means for advertising one or more entities not associated with a vehicle make;
a second means for attaching said second means for advertising to the vehicle by way of the base, and
a second means for detaching said second means for advertising from the vehicle.

25) The system of claim 22, wherein said means for advertising is a low-profile medallion having a face on which said indicia is shown.

26) The system of claim 22, wherein said means for attaching comprises means for attaching said advertisement to a surface of a vehicle by way of a base.

27) The system of claim 22, wherein said means for attaching comprises means for attaching said advertisement to a hood of a vehicle by way of a base.

28) The system of claim 22, wherein said means for attaching comprises:
a plate,
at least one foot connected to the plate, each of said at least one foot being feedable into a recess formed by at least one extension protruding from the base, and
at least one clip clippable to said at least one extension and unclippable by way of a key.

29) The system of claim 22, wherein said means for advertising use a base already disposed on the vehicle.

30) The system of claim 22, wherein said indicia comprises means for advertising at least one athletic franchise.

31) The system of claim 22, wherein said indicia comprises means for advertising at least one product.

32) A device for advertising, the device comprising:
a low-profile base comprising an adhesive layer, which attaches to a vehicle by said adhesive layer;
an object displaying advertising indicia, said object comprising an attachment mechanism which attaches to said low-profile base and which is detachable from said low-profile base; and
a cap, said cap comprising an attachment mechanism which attaches to said low-profile base and which is detachable from said low-profile base.

33) The device of claim 32, wherein said cap comprises a low-profile medallion.
